(19) United States
(12) Patent Application Publication
(10) Pub. No.: US 2025/0299138 A1
(43) Pub. Date: Sep. 25, 2025

(54) SERVER AND METHOD FOR FACILITATING VERIFICATION OF LIFE-CYCLE ASSESSMENT DATA

(71) Applicant: Hitachi, Ltd., Tokyo (JP)

(72) Inventors: Lan LAN, Mapletree Business City (SG); Wujuan LIN, Mapletree Business City (SG)

(73) Assignee: Hitachi, Ltd., Tokyo (JP)

(21) Appl. No.: 19/011,155

(22) Filed: Jan. 6, 2025

(30) Foreign Application Priority Data
Mar. 19, 2024 (SG) 10202400773V

(51) Int. Cl. G06Q 10/0637; G06Q 10/10

(52) U.S. Cl. CPC G06Q 10/0637; G06Q 10/103

(57) ABSTRACT

Aspects concern a server comprising: a memory configured to store instructions; and a processor configured to execute the stored instructions and configured to: detect life-cycle assessment (LCA) data from an LCA data source; identify information relating to a quality of the LCA data and a quality of the LCA data source using a natural language processing (NLP) technique; evaluate credibility of the LCA data source using a first machine learning model based on the identified information relating to the quality of the LCA data source; evaluate a plausibility of an impact level using a second machine learning model based on the identified information relating to the quality of the LCA data; and verify the LCA data as either valid data or invalid data, based on the evaluated credibility of the LCA data source and the evaluated plausibility of the impact level.

### TECHNICAL FIELD

Various embodiments relate to a server and a method for facilitating a verification of life-cycle assessment (LCA) data.

### BACKGROUND

A life-cycle assessment (LCA) has received more and more attention by industry and authorities as an important tool for a design and an assessment of an environmental sustainability. Accuracy of the LCA may rely on a quality and accuracy of LCA data. However, maintaining a high-quality and reliable LCA database for LCA tools may be challenging due to a requirement of having up-to-date and credible data from multiple sources in the LCA database. For example, when creating a building LCA tool, an owner of the LCA tool may spend a lot of resources to maintain the LCA database to keep the data up-to-date, reliable and transparent.

Existing LCA tools may address timeliness and reliability challenges through periodic data reviews and updates, accompanied by metadata indicating data origins, using computer-based statistical processing technologies. However, human resource limitations and limited update rates may affect effectiveness of the LCA process. When the LCA data beyond the existing LCA database is required for a project, applicants for the project may need to request data addition, facing a prolonged validation and integration waiting period. This waiting period may hamper efficiency and responsiveness of the LCA process for the applicants.

In tackling an automation of an ingestion and processing of the LCA data, rule-based methods and natural language processing (NLP) techniques may be used to predict credibility of an LCA data source. However, applying a basic rule-based approach may lead to suboptimal outcomes, such as accepting inaccurate data or rejecting accurate data. For the LCA data, these challenges may be exacerbated, particularly when assessing environmental product declarations (EPDs) with digitally reproduced third-party verifiers' signatures. Certain EPDs may display digitally reproduced signatures of the third-party verifiers on a cover page. However, these verifiers may have only endorsed software generating the EPD, not a content of the EPD itself. In addition, The NLP techniques alone may be insufficient, and a more comprehensive model may be needed to categorise LCA data sources based on specific features like adherence to international standards, a methodology disclosure, a technical committee and board member characteristics, an update frequency, and so on. Additionally, a tailored data quality analysis for the LCA data may be needed to enhance a credibility assessment of the LCA data and the LCA data sources, but it has not been addressed by conventional technologies.

Therefore, there exists a need to provide an improved solution to facilitate a verification of the LCA data for the project.

### SUMMARY

According to various embodiments, there is a server for facilitating a verification of life-cycle assessment (LCA) data, the server comprising: a memory configured to store instructions; and a processor configured to execute the stored instructions and configured to: detect LCA data from an LCA data source; identify information relating to a quality of the LCA data and a quality of the LCA data source using a natural language processing (NLP) technique; evaluate credibility of the LCA data source using a first machine learning model based on the identified information relating to the quality of the LCA data source; evaluate a plausibility of an impact level using a second machine learning model based on the identified information relating to the quality of the LCA data; and verify the LCA data as either valid data or invalid data, based on the evaluated credibility of the LCA data source and the evaluated plausibility of the impact level.

In some embodiments, the processor is further configured to: obtain project data for a project from a project database; and store the project data in a data storage as temporary data, wherein the data storage stores at least one of a trusted data source, an invalid data source, invalid data, and a valid data format.

In some embodiments, the processor is further configured to identify the LCA data that needs to be verified among the project data stored as the temporary data, based on at least one of the invalid data source, the invalid data, and the valid data format stored in the data storage and an internal LCA database.

In some embodiments, the processor is further configured to identify the LCA data source whose credibility needs to be evaluated among the identified LCA data, based on the trusted data source saved in the data storage.

In some embodiments, the first machine learning model is a classification machine learning model, and the second machine learning model is a regression machine learning model.

In some embodiments, the processor is configured to evaluate the credibility of the LCA data source by: collecting data including the information relating to the quality of the LCA data and the quality of the LCA data source from the LCA data source using a data collection module; extracting the information relating to the quality of the LCA data and the quality of the LCA data source from the collected data using a data extraction module; verifying the extracted information based on information obtained from a trusted LCA data source using a data verification module; evaluating the credibility of the LCA data source using a text classification module; predicting the credibility of the LCA data source using a credibility prediction module; evaluating themes of the LCA data source using a theme evaluation module; evaluating the quality of the LCA data using an LCA data analysis module; and generating a final evaluation result using a result generation module.

In some embodiments, the processor is further configured to search the LCA data in the LCA data source which is evaluated credible.

In some embodiments, the processor is further configured to: for another LCA data that is not found in the LCA data source, analyse likelihood that the another LCA data is true based on the impact level; and generate an action item for a verifier based on the likelihood that the another LCA data is true.

In some embodiments, the processor is further configured to, for the LCA data that is found in the LCA data source, extract data relating to the quality of the LCA data, evaluate data completeness of the LCA data, evaluate the quality of the LCA data against pre-defined LCA data quality criteria, process the LCA data, and evaluate the plausibility of the impact level.

In some embodiments, the processor is further configured to: check if all the LCA data has been verified; for the project that all the LCA data has been verified, send a verification result to the project database; and for the project that at least a part of the LCA data has not been verified, send the verification result to the project database, and return the project to an applicant for an action.

According to various embodiments, there is a method for facilitating a verification of life-cycle assessment (LCA) data, the method comprising: detecting LCA data from an LCA data source; identifying information relating to a quality of the LCA data and a quality of the LCA data source using a natural language processing (NLP) technique; evaluating credibility of the LCA data source using a first machine learning model based on the identified information relating to the quality of the LCA data source; evaluating a plausibility of an impact level using a second machine learning model based on the identified information relating to the quality of the LCA data; and verifying the LCA data as either valid data or invalid data, based on the evaluated credibility of the LCA data source and the evaluated plausibility of the impact level.

In some embodiments, the method further comprises: obtaining project data for a project from a project database; and storing the project data in a data storage as temporary data, wherein the data storage stores at least one of a trusted data source, an invalid data source, invalid data, and a valid data format.

In some embodiments, the method further comprises: identifying the LCA data that needs to be verified among the project data stored as the temporary data, based on at least one of the invalid data source, the invalid data, and the valid data format stored in the data storage and an internal LCA database.

In some embodiments, the method further comprises: identifying the LCA data source whose credibility needs to be evaluated among the identified LCA data, based on the trusted data source saved in the data storage.

In some embodiments, the first machine learning model is a classification machine learning model, and the second machine learning model is a regression machine learning model.

In some embodiments, the evaluating the credibility of the LCA data source further comprises: collecting data including the information relating to the quality of the LCA data and the quality of the LCA data source from the LCA data source using a data collection module; extracting the information relating to the quality of the LCA data and the quality of the LCA data source from the collected data using a data extraction module; verifying the extracted information based on information obtained from a trusted LCA data source using a data verification module; evaluating the credibility of the LCA data source using a text classification module; predicting the credibility of the LCA data source using a credibility prediction module; evaluating themes of the LCA data source using a theme evaluation module; evaluating the quality of the LCA data using an LCA data analysis module; and generating a final evaluation result using a result generation module.

In some embodiments, the method further comprises: searching the LCA data in the LCA data source which is evaluated credible.

In some embodiments, the method further comprises: for another LCA data that is not found in the LCA data source, analysing likelihood that the another LCA data is true based on the impact level; and generating an action item for a verifier based on the likelihood that the another LCA data is true.

In some embodiments, the method further comprises: for the LCA data that is found in the LCA data source, extracting data relating to the quality of the LCA data, evaluate data completeness of the LCA data, evaluating the quality of the LCA data against pre-defined LCA data quality criteria, processing the LCA data, and evaluating the plausibility of the impact level.

In some embodiments, the method further comprises: checking if all the LCA data has been verified; for the project that all the LCA data has been verified, sending a verification result to the project database; and for the project that at least a part of the LCA data has not been verified, sending the verification result to the project database, and returning the project to an applicant for an action.

According to various embodiments, a computer program product, comprising instructions to cause the server of any one of the above embodiments to execute the steps of the method of any one of the above embodiments is provided.

According to various embodiments, a computer-readable medium having stored thereon the above computer program product is provided.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 is a block diagram illustrating a server for facilitating a verification of life-cycle assessment (LCA) data according to various embodiments.

FIG. 2 is a block diagram illustrating a system architecture of an artificial intelligence (AI) verifier according to various embodiments.

FIG. 3 is a flow diagram illustrating a general process of updating an LCA database according to various embodiments.

FIG. 4 is a flow diagram illustrating an overall verification process for LCA data from an LCA project according to various embodiments.

FIG. 5 is a flow diagram illustrating a process to identify LCA data which needs to be verified with external data according to various embodiments.

FIG. 6 is a flow diagram illustrating an LCA data verification process in detail according to various embodiments.

FIG. 7 is a flow diagram illustrating a process when a data source is not accessible by an established connection according to various embodiments.

FIG. 8 is a flow diagram illustrating a process, when a data source is accessible by an established connection, but LCA data is not found according to various embodiments.

FIG. 9 is a flow diagram illustrating a process to evaluate credibility of a data source using a Source Verify AI according to various embodiments.

FIG. 10 is a flow diagram illustrating a process to predict data source credibility using a classification machine learning model according to various embodiments.

FIG. 11 is a flow diagram illustrating a process to predict reasonable impact levels according to various embodiments.

FIG. 12 is a flow diagram illustrating a process to predict a reasonable range of impact levels using a regression machine learning model according to various embodiments.

FIG. 13 is a flow diagram illustrating a process to evaluate an LCA data quality according to various embodiments.

FIG. 14 is a block diagram illustrating a system architecture of an LCA tool using a blockchain according to various embodiments.

FIG. 15 is a flow diagram illustrating a method for facilitating a verification of LCA data according to various embodiments.

### DESCRIPTION

Embodiments described below in context of the method are analogously valid for the server, and vice versa. Furthermore, it will be understood that the embodiments described below may be combined, for example, a part of one embodiment may be combined with a part of another embodiment.

It will be understood that any property described herein for a specific device may also hold for any device described herein. Furthermore, it will be understood that for any device described herein, not necessarily all the components described must be enclosed in the device, but only some (but not all) components may be enclosed.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, structure or any part of any device or structure. In addition, the singular terms “a”, “an”, and “the” include plural references unless context clearly indicates otherwise. Similarly, the word “or” is intended to include “and” unless the context clearly indicates otherwise.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

Throughout the description, the term of “life-cycle assessment (LCA)” refers to a systematic method for evaluating environmental impacts of at least one of a product, a process, and an activity throughout its entire life cycle, from an extraction of a raw material to a disposal.

Throughout the description, the term of “LCA tool” refers to an LCA software tool which may be a computer program or an application specifically designed to assist users in conducting life-cycle assessments. The LCA software tool may typically provide functionalities such as a data input and management, an environmental impact assessment, and an interpretation of results, and often have databases with environmental data to help the users estimate the impact accurately.

Throughout the description, the term of “LCA database” refers to a structured collection of data and information relating to the environmental impacts associated with various products, processes, materials, and activities throughout their life cycles. The LCA database may be a component of the LCA tool.

Throughout the description, the term of “LCA data” refers to information and measurements used in the life-cycle assessments. The LCA data may cover details like a resource use, energy consumption, and impact indicators (for example, global warming potential (GWP) expressed in carbon dioxide equivalents). The LCA data may be presented in various formats, such as Environmental Product Declarations (EPDs) and material/product certification data.

Throughout the description, the term of “LCA report” refers to a comprehensive document that presents findings and results of a study of the life-cycle assessments. The LCA report may be an output of the LCA tool.

Throughout the description, the term of “LCA calculator” refers to a computational core of the LCA tool. The LCA calculator may perform calculations needed to assess the environmental impacts by processing the LCA data and applying at least one mathematical model.

Throughout the description, the term of “product impact level” refers to an effect the product has on the environment, typically measured using specific environmental indicators such as the global warming potential (GWP).

In order that the invention may be readily understood and put into practical effect, various embodiments will now be described by way of examples and not limitations, and with reference to the figures.

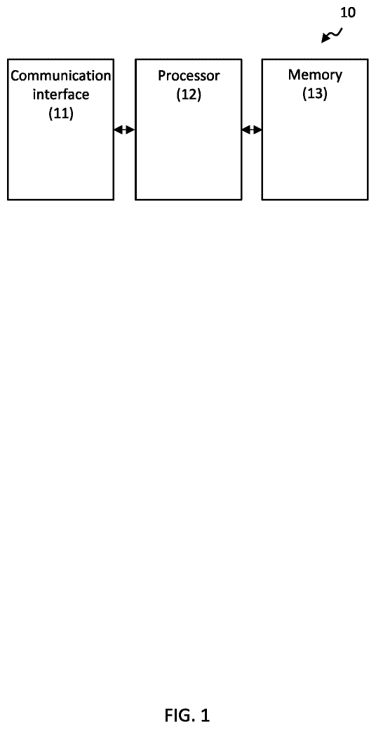

FIG. 1 is a block diagram illustrating a server 10 for facilitating a verification of life-cycle assessment (LCA) data according to various embodiments.

In some embodiments, the server 10, for example, implemented by a server computer, may include a communication interface 11, a processor 12, and a memory 13.

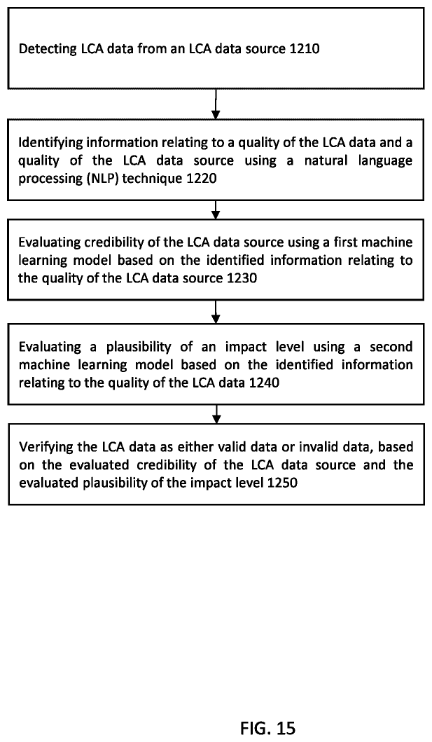

In some embodiments, the memory 13 (also referred to as a “database (DB)” or a “storage”) may store input data and/or output data temporarily or permanently. In some embodiments, the memory 13 may store program code which allows the server 10 to perform a method (as will be described with reference to FIG. 15). In some embodiments, the program code may be embedded in a Software Development Kit (SDK). The memory 13 may include an internal memory of the server 10 and/or an external memory. The external memory may include, but is not limited to, an external storage medium, for example, a memory card, a flash drive, and a web storage.

In some embodiments, the communication interface 11 may allow one or more external systems to communicate with the processor 12 via a network. In some embodiments, the communication interface 11 may transmit signals to the external systems, and/or receive signals from the external systems via the network.

In some embodiments, the processor 12 may include, but is not limited to, a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), or any combination thereof. Any other kind of implementation of the respective functions, which will be described below in further detail, may also be understood as the processor 12.

In some embodiments, the processor 12 may be connectable to the communication interface 11. In some embodiments, the processor 12 may be arranged in data or signal communication with the communication interface 11.

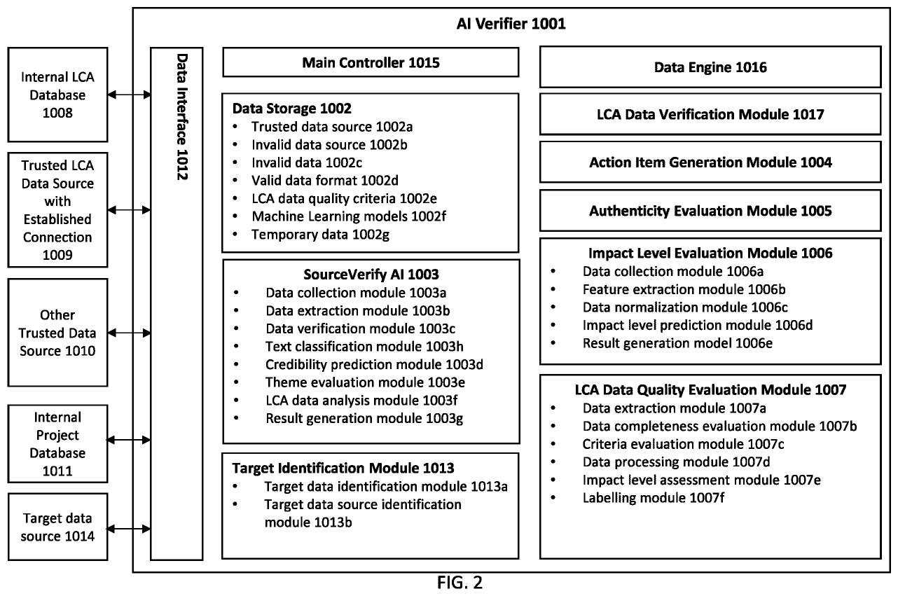

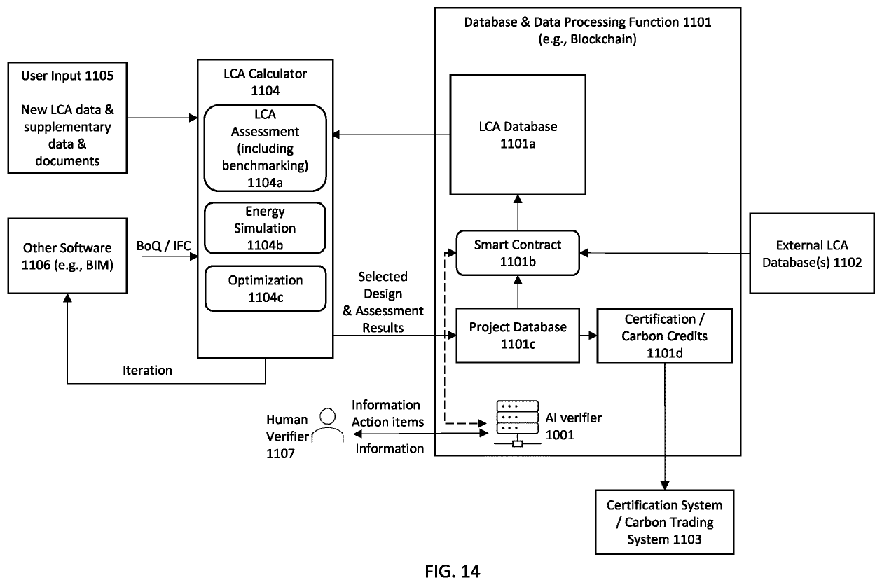

In some embodiments, the processor 12 may be referred to as an artificial intelligence (AI) verifier 1001 (as will be described with reference to FIG. 2). In some embodiments, the processor 12 may create an LCA database (also referred to as an “internal LCA database 1008” (as will be described with reference to FIG. 2) or an “LCA database 1101a” (within a database & data processing function 1101) (as will be described with reference to FIG. 14)).

In some embodiments, an external LCA database 1102 (also referred to as a “trusted LCA data source with an established connection 1009” and/or an “other trusted data source 1010” (as will be described with reference to FIG. 2)) may be provided outside the database & data processing function 1101 (as will be described with reference to FIG. 14).

In some embodiments, the memory 13 may include the internal LCA database 1008. In some other embodiments, the internal LCA database 1008 may be stored in another storage outside the memory 13.

In some embodiments, the processor 12 may add a project into an internal project database 1011 (as will be described with reference to FIG. 2) (also referred to as a “project database 1101c” (as will be described with reference to FIG. 14)). In some other embodiments, adding the project into the internal project database 1011 may be performed by another processor (not shown) which may be different from the processor 12 (the AI verifier 1001).

In some embodiments, the processor 12 may detect LCA data, for example, new LCA data, from an LCA data source (including a target data source 1014, the trusted LCA data source with an established connection 1009, and the other trusted data source 1010) (as will be described with reference to FIG. 2). In some embodiments, the LCA data source may store the LCA data. The processor 12 may obtain the new LCA data from the LCA data source, so that the processor 12 may verify the new LCA data obtained from the LCA data source.

In some embodiments, the processor 12 may identify information, for example, key information, relating to a quality of the LCA data and a quality of the LCA data source using a natural language processing (NLP) technique. In some embodiments, the key information relating to the quality of the LCA data may include, but is not limited to, a material/product type, material/product characteristics (for example, high/low density), an origin, data types, etc. In some embodiments, the key information relating to the quality of the LCA data source may include, but is not limited to, a reference to international standards, a disclosure of a methodology, characteristics of technical committee members, a frequency of updates, etc. In some embodiments, the processor 12 may obtain the information relating to the quality of the LCA data and the quality of the LCA data source from the LCA data source.

In some embodiments, the processor 12 may evaluate the credibility of the LCA data source. In some embodiments, the processor 12 may collect data including the information relating to the quality of the LCA data and the quality of the LCA data source from the LCA data source using a data collection module, extract the information relating to the quality of the LCA data and the quality of the LCA data source from the collected data using a data extraction module, verify the extracted information based on information obtained from at least one trusted LCA data source 1009, 1010 (as will be described with reference to FIG. 2) using a data verification module, evaluate the credibility of the LCA data source using a text classification module, predict the credibility of the LCA data source using a credibility prediction module, evaluate themes of the LCA data source using a theme evaluation module, evaluate the quality of the LCA data using an LCA data analysis module, and generate a final evaluation result using a result generation module, to evaluate the credibility of the LCA data source.

In some embodiments, the at least one trusted LCA data sources 1009, 1010 may have an established connection with the processor 12. In some other embodiments, the at least one trusted LCA data sources 1009, 1010 may not have the established connection with the processor 12, and may obtain the information from a non-connected source using techniques such as Web Scraping.

In some embodiments, the processor 12 may evaluate credibility of the LCA data source using a first machine learning model, based on the identified information relating to the quality of the LCA data source. In some embodiments, the first machine learning model may include a classification machine learning (ML) model. In some embodiments, the processor 12 may predict the credibility of the LCA data source using a predefined machine learning model based on at least one of the key information relating to the quality of the LCA data source, including, for example, the reference to international standards, the disclosure of methodology, the characteristics of technical committee members, the frequency of updates, etc.

In some embodiments, the processor 12 may evaluate a plausibility of an impact level using a second machine learning model based on the identified information relating to the quality of the LCA data. In some embodiments, the second machine learning model may include a regression machine learning (ML) model. In some embodiments, the processor 12 may use a pre-trained regression machine learning model to predict reasonable impact levels based on at least one of the key information relating to the quality of the LCA data, including, for example, the material/product type, the material/product characteristics (for example, the high/low density), the origin, the data types, etc.

In some embodiments, the processor 12 may verify the LCA data, based on the evaluated credibility of the LCA data source and the evaluated plausibility of the impact level. In some embodiments, the processor 12 may verify the LCA data as either valid data or invalid data. In some embodiments, the processor 12 may update the internal LCA database 1008 using the verified LCA data. For example, the processor 12 may add the verified LCA data into the internal LCA database 1008, and link the verified LCA data to the project.

In some embodiments, the processor 12 may obtain project data for the project from the project database 1011 (also referred to as an “internal project database”) (as will be described with reference to FIG. 2). In some embodiments, the processor 12 may store the project data in a data storage 1002, as temporary data 1002g (as will be described with reference to FIG. 2). In some embodiments, the data storage 1002 may store at least one of a trusted data source 1002a, an invalid data source 1002b, invalid data 1002c, and a valid data format 1002d (as will be described with reference to FIG. 2).

In some embodiments, the processor 12 may identify the LCA data that needs to be verified among the project data stored as the temporary data 1002g, based on at least one of the invalid data source 1002b, the invalid data 1002c, and the valid data format 1002d stored in the data storage 1002 and the internal LCA database 1008. In some embodiments, the processor 12 may identify the LCA data source whose credibility needs to be evaluated among the identified LCA data, based on the trusted data source 1002a saved in the data storage 1002.

In some embodiments, the processor 12 may search the LCA data in the LCA data source which is evaluated credible. In some embodiments, after searching the LCA data, for the LCA data that is found in the LCA data source, the processor 12 may extract data relating to the quality of the LCA data, evaluate data completeness of the LCA data, and evaluate the quality of the LCA data against pre-defined LCA data quality criteria. In some embodiments, thereafter, the processor 12 may process the LCA data, and evaluate the plausibility of the impact level. In some embodiments, after searching the LCA data, for another LCA data that is not found in the LCA data source, the processor 12 may analyse likelihood that the another LCA data is true based on the impact level. In some embodiments, thereafter, the processor 12 may generate an action item for a verifier, for example, a human verifier, based on the likelihood that the another LCA data is true.

In some embodiments, the processor 12 may check if all the LCA data has been verified. In some embodiments, for the project that all the LCA data has been verified, the processor 12 may send a verification result to the internal project database 1011. In some embodiments, for the project that at least a part of the LCA data has not been verified, the processor 12 may send the verification result to the internal project database 1011, and return the project to an applicant for the project for an action.

FIG. 2 is a block diagram illustrating a system architecture of an artificial intelligence (AI) verifier 1001 according to various embodiments.

In some embodiments, the system may include, but is not limited to, at least one of the AI verifier 1001, an internal LCA database 1008 (also referred to as an “LCA database”), a trusted LCA data source 1009 (also referred to as a “trusted external data source” or “trusted external LCA data source”) with an established connection with the AI verifier 1001, other trusted data source 1010, an internal project database 1011, and a target data source 1014 (also referred to as an “LCA data source” or a “target LCA data source”). In some embodiments, the trusted LCA data source 1009 may have the established connection with the AI verifier 1001 using, for example, a restful API (application programming interface).

In some embodiments, the AI verifier 1001 may include, but is not limited to, at least one of a data interface 1012, a main controller 1015, a data storage 1002, a SourceVerify AI 1003, a target identification module 1013, a data engine 1016, an LCA data verification module 1017, an action item generation module 1004, an authenticity evaluation module 1005, an impact level evaluation module 1006, and an LCA data quality evaluation module 1007.

In some embodiments, the data interface 1012 may facilitate a data interchange between the AI verifier 1001 and at least one of the internal LCA database 1008, the trusted LCA data source 1009, the other trusted data source 1010, the internal project database 1011, and the target data source 1014.

In some embodiments, the main controller 1015 may control a sequence of processes by calling other modules in the AI verifier 1001.

In some embodiments, the data engine 1016 may read and write data in the data storage 1002. In some embodiments, the data engine 1016 may collect data from at least one of the internal LCA database 1008, the trusted LCA data source 1009, the other trusted data source 1010, the internal project database 1011, and the target data source 1014, via the data interface 1012. In some embodiments, the data engine 1016 may send data to at least one of the internal LCA database 1008, the trusted LCA data source 1009, the other trusted data source 1010, the internal project database 1011, and the target data source 1014, via the data interface 1012. In some embodiments, the data engine 1016 may collect data from the other modules in the AI verifier 1001, and send data to the other modules in the AI verifier 1001.

In some embodiments, the data engine 1016 may establish a connection (for example, using API) with the trusted LCA data source 1009 (for example, an EPD (Environmental Product Declaration) database) via the data interface 1012, to verify if new LCA data is from the target data source 1014 and is valid. In some embodiments, the data engine 1016 may establish the connection with the trusted LCA data source 1009 via the data interface 1012, to verify information from the target data source 1014 (for example, as a cross-reference), to detect and obtain the new LCA data in the trusted LCA data source 1009 so as to update the internal LCA database 1008. In some embodiments, the data engine 1016 may send data to at least one of the internal LCA database 1008 and the internal project database 1011 via the data interface 1012. In some embodiments, the data engine 1016 may receive data from at least one of the internal LCA database 1008 and the internal project database 1011 via the data interface 1012. In some embodiments, the data engine 1016 may access and collect information/data from at least one of the other trusted data source 1010 and the target data source 1014 using at least one technique, such as Web Scraping, via the data interface 1012. In some embodiments, the data engine 1016 may receive data from the other modules in the AI verifier 1001, and send data to the other modules in the AI verifier 1001. In some embodiments, the data engine 1016 may compare and generate comparison results based on the accessed data. In some embodiment, the data engine 1016 may replace functions of a data collection module 1003a and a data collection module 1006a.

In some embodiments, the data storage 1002 may store at least one of a trusted data source 1002a, an invalid data source 1002b, invalid data 1002c, a valid data format 1002d, LCA data quality criteria 1002e, machine learning models 1002f, and temporary data 1002g.

In some embodiments, the target identification module 1013 may include, but is not limited to, at least one of a target data identification module 1013a, and a target data source identification module 1013b. In some embodiments, the target data identification module 1013a may identify the LCA data which needs to be verified, as target LCA data. In some embodiments, the target data source identification module 1013b may identify the target data source 1014 whose credibility needs to be assessed.

In some embodiments, the Source Verify AI 1003 may include, but is not limited to, at least one of the data collection module 1003a, a data extraction module 1003b, a data verification module 1003c, a text classification module 1003h, a credibility prediction module 1003d, a theme evaluation module 1003e, an LCA data analysis module 1003f, and a result generation module 1003g. The Source Verify AI 1003 may utilise at least one of the above-mentioned modules to verify the credibility of the target data source 1014.

In some embodiments, the action item generation module 1004 may generate action items for the verifier, for example, the human verifier.

In some embodiments, the authenticity evaluation module 1005 may evaluate the likelihood of the LCA data being true.

In some embodiments, the impact level evaluation module 1006 may include, but is not limited to, at least one of the data collection module 1006a, a feature extraction module 1006b, a data normalization module 1006c, an impact level prediction module 1006d, and a result generation module 1006e. The impact level evaluation module 1006 may utilise at least one of the above-mentioned modules to generate reasonable values of the product impact level and the plausibility of the product impact level.

In some embodiments, the LCA data quality evaluation module 1007 may include, but is not limited to, at least one of a data extraction module 1007a, a data completeness evaluation module 1007b, a criteria evaluation module 1007c, a data processing module 1007d, an impact level assessment module 1007e, and a labelling module 1007f. The LCA data quality evaluation module 1007 may utilise at least one of the above-mentioned modules to evaluate the quality of the target LCA data.

In some embodiments, the LCA data verification module 1017 may verify the target LCA data, by comparing the target LCA data with valid LCA data obtained from the at least one of the trusted LCA data sources 1009, 1010 and/or the internal LCA database 1008.

In some embodiments, the functions which were mentioned above and will be described below may be realised in different module settings. For example, different modules may be merged into one module which fulfils all the functions of the different modules being merged. One module may be divided into multiple modules which together fulfil all the functions of the module being split. Some of the functions may be realised within the LCA software but outside the AI verifier 1001.

In some embodiments, the functions which were mentioned above and will be described below may be realised in a user-interactive manner, in which users may get a real-time display of information and instructions from the AI verifier 1001 while inputting data. Alternatively, it may be realised in a non-user-interactive manner, in which the users may submit project information and the AI verifier 1001 may return all the generated information and instructions for different LCA data in the project.

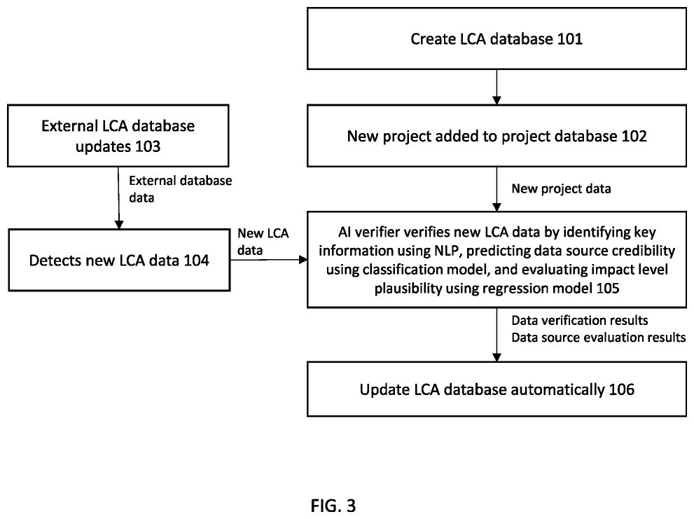

FIG. 3 is a flow diagram illustrating a general process of updating an LCA database according to various embodiments.

In some embodiments, in step 101, the internal LCA database 1008 may be created. In some embodiments, in step 102, a new project may be added to the internal project database 1011.

In some embodiments, in step 103, the external LCA database 1002 (shown as a “trusted LCA data source with an established connection 1009” and/or an “other trusted data source 1010” in FIG. 2) may be updated. In some embodiments, in step 104, a program (a database & data processing function 1101) (as will be described with reference to FIG. 14) may detect and obtain the new LCA data from the external LCA database.

In some embodiments, in step 105, the AI verifier 1001 may verify the new LCA data obtained from the steps 102 and 104, by identifying the key information using the natural language processing (NLP) techniques, predicting the credibility of the target LCA data source 1014 using the pre-defined classification model, and evaluating the plausibility of the impact level using the pre-defined regression model.

In some embodiments, in step 106, the program (the database & data processing function 1101) may update the internal LCA database 1008, for example, automatically, based on the data verification results, and the data source evaluation results from the step 105.

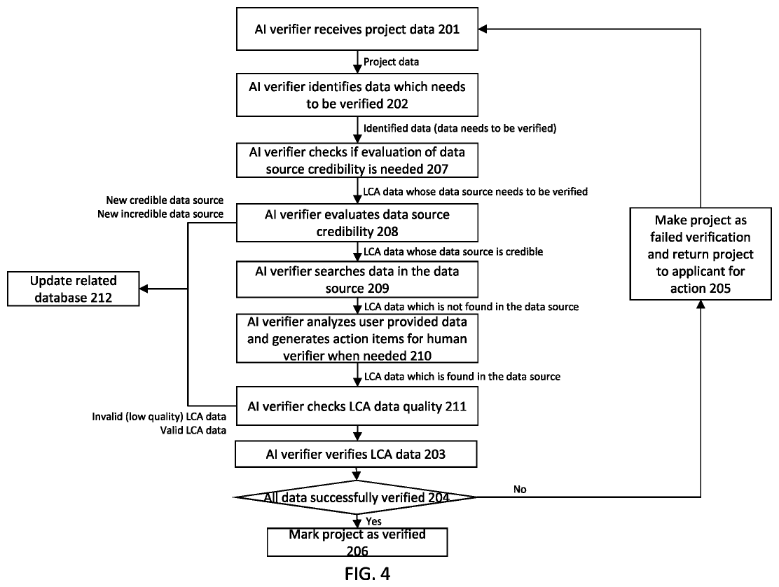

FIG. 4 is a flow diagram illustrating an overall verification process for LCA data from an LCA project according to various embodiments. FIG. 4 shows the overall verification process for the LCA data from the LCA project in the step 102 of FIG. 3.

In some embodiments, for the new LCA data, which is detected from the external LCA database 1002 (shown as a “trusted LCA data source with an established connection 1009” and/or an “other trusted data source 1010” in FIG. 2) in the step 104 of FIG. 3, the verification process may be the same except that steps 201, 202, 204, 205 and 206, which may relate to the verification of the project, may be excluded from the process.

As shown in FIG. 4, in some embodiments, in step 201, the data engine 1016 may receive the project data from the internal project database 1011 via the data interface 1012, and store the project data in the data storage 1002 as the temporary data 1002g.

In some embodiments, in step 202, the target data identification module 1013a may identify the LCA data that needs to be verified among the project data, by checking the LCA data against at least one of the invalid data source list 1002b, the invalid data list 1002c, the valid data format 1002d, and data from the internal LCA database 1008 which may be accessed by the data engine 1016 via the data interface 1012. The identified LCA data that needs to be verified may be referred to as a target LCA data.

In some embodiments, in step 207, the target data source identification module 1013bmay identify the target data source 1014 whose credibility needs to be evaluated, by checking the target data source 1014 against the trusted data source list 1002a in the data storage 1002.

In some embodiments, in step 208, the Source Verify AI 1003 may evaluate the credibility of the target data source 1014 by collecting data relating to the quality of the target data source 1014 and the quality of the target LCA data from the target data source 1014 using the data collection module 1003a, extracting the key information using the data extraction module 1003b, verifying the key information using the data verification module 1003c based on information obtained from at least one of the trusted data sources 1009 and 1010 by the data collection module 1003a via the data interface 1012, evaluating the credibility of the target data source 1014 using the text classification module 1003h, predicting the credibility of the target data source 1014 using the credibility prediction module 1003d, evaluating themes of the target data source 1014 using the theme evaluation module 1003e, evaluating the quality of the target LCA data using the LCA data analysis module 1003f, and generating final evaluation results using the result generation module 1003g.

In some embodiments, in the step 208, modules including at least one of the data extraction module 1003b, the text classification module 1003h, and the theme evaluation module 1003e may use multiple natural language processing machine learning models from the machine learning models 1002f. In some embodiments, in the step 208, the credibility prediction module 1003d may use the classification machine learning model from the machine learning models 1002f. In some embodiments, in the step 208, the LCA data analysis module 1003f may call the impact level evaluation module 1006, which may use the regression machine learning model from the machine learning models 1002f.

In some embodiments, in step 209, the data engine 1016 may search the target LCA data, whose target data source 1014 is found credible, in respective trusted data sources 1009, 1010 or target data source 1014 via the data interface 1012.

In some embodiments, in step 210, for the LCA data which is not found in its target data source 1014 in the step 209, the authenticity evaluation module 1005 may analyse the likelihood that the LCA data is true based on the target LCA data, the internal LCA database 1008, and the predicted impact levels generated by the impact level evaluation module 1006. In some embodiments, in the step 210, the impact evaluation module 1006 may use the regression machine learning model from the machine learning models 1002f. In some embodiments, in the step 210, the action item generation module 1004 may generate the action items for the verifier, for example, the human verifier, based on the likelihood of the LCA data being true, which is generated by the authenticity evaluation module 1005.

In some embodiments, in step 211, for the target LCA data which is found in the target data source 1014, the LCA data quality evaluation module 1007 may evaluate the quality of the target LCA data, by extracting relevant data from the target LCA data using the data extraction module 1007a, evaluating data completeness of the target LCA data using the data completeness evaluation module 1007b, evaluating the quality of the target LCA data against the pre-defined LCA data quality criteria 1002e using the criteria evaluation module 1007c, processing the target LCA data using the data processing module 1007d, assessing the plausibility of the impact level using the impact level assessment module 1007e, and labelling the target LCA data using the labelling module 1007f.

In some embodiments, in the step 211, the impact level assessment module 1007e may generate the impact level assessment results based on the predicted impact level from the impact level evaluation module 1006, which may use the regression machine learning model from the machine learning models 1002f.

In some embodiments, in step 212, the data engine 1016 may update the trusted data source 1002a and the invalid data source 1002b based on the new credible data source and the new incredible data source identified by the step 208.

In some embodiments, in the step 212, a data engine (not shown) may update the internal LCA database 1008 based on the updated trusted data source 1002a, provided by the data engine 1016 via the data interface 1012.

In some embodiments, in the step 212, the data engine 1016 may update the invalid data 1002c and the valid data format 1002d based on the invalid target LCA data and the valid target LCA data identified by the step 211.

In some embodiments, in the step 212, a data engine (not shown) may update the internal LCA database 1008 based on the valid target LCA data identified by the step 211, provided by the data engine 1016 via the data interface 1012.

In some embodiments, in step 203, the LCA data verification 1017 may verify the target LCA data by comparing the target LCA data with the valid LCA data obtained from the at least one of the trusted LCA data sources 1009, 1010 and/or the internal LCA database 1008.

In some embodiments, in step 204, the main controller 1015 may check if all target LCA data has been successfully verified.

In some embodiments, in step 206, for a project with all target LCA data successfully verified, the data engine 1016 may send the verification result to the internal project database 1011 via the data interface 1012.

In some embodiments, in step 205, for a project with any target LCA data failed verification, the data engine 1016 may send the verification result to the internal project database 1011 via the data interface 1012. In some embodiments, in the step 205, a controller (not shown) may return the project to the applicant for the action.

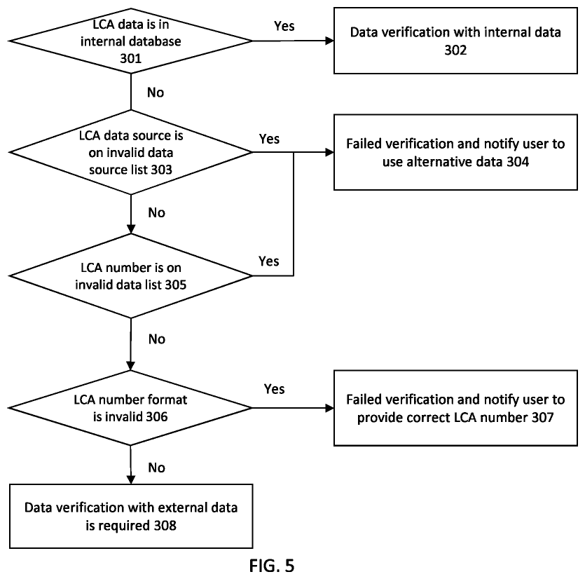

FIG. 5 is a flow diagram illustrating a process to identify LCA data which needs to be verified with external data according to various embodiments. This process may relate to the step 202 as described with reference to FIG. 4.

In some embodiments, in step 301, the target data identification module 1013a may check whether the LCA data exists in the internal LCA database 1008. In some embodiments, if the LCA data exists in the internal LCA database 1008, the LCA data may be verified based on the data in the internal LCA database 1008 in step 302. The LCA data which may need to be verified may be identified as the target LCA data.

In some embodiments, otherwise, the target data identification module 1013a may check whether the target data source 1014 exists in the invalid data source list 1002b, in step 303. In some embodiments, if the target data source 1014 exists in the invalid data source list 1002b, the data engine 1016 may send information, indicating that the LCA data is from an invalid data source, to the internal project database 1011 via the data interface 1012. In some embodiments, the information, indicating that the LCA data is from the invalid data source, may also be received by a controller (not shown), which may mark the LCA data and respective project as “failed verification” and notify the user to use alternative LCA data in step 304.

In some embodiments, if the target data source 1014 is not on the invalid data source list 1002b, the target data identification module 1013a may check if an LCA number (also referred to as an “LCA registration number”) exists on the invalid data list 1002c in step 305. For example, the LCA number may be defined as an identifier assigned to a specific Life Cycle Assessment study, and may be used for tracking, referencing, or managing the associated LCA data and documentation. In some embodiments, if the LCA number exists on the invalid data list 1002c, the data engine 1016 may send information, indicating that the LCA data is invalid data, to the internal project database 1011 via the data interface 1012. In some embodiments, the information, indicating that the LCA data is the invalid data, may also be received by a controller (not shown), which may mark the LCA data and respective project as “failed verification” and notify the user to use alternative LCA data in the step 304.

In some embodiments, if the LCA number is not on the invalid data list 1002c, the target data identification module 1013a may check the LCA number's format against the valid data format 1002d in step 306. In some embodiments, if the LCA number format is considered to be invalid, the data engine 1016 may send information, indicating that the LCA number format is invalid, to the internal project database via the data interface 1012. In some embodiments, the information, indicating that the LCA number format is invalid, may also be received by a controller (not shown), which may mark the LCA data and respective project as “failed verification” and notify the user to provide a correct LCA number in step 307.

In some embodiments, if the LCA number is considered to be valid, the LCA data may be identified to be target LCA data which needs to be verified with external data.

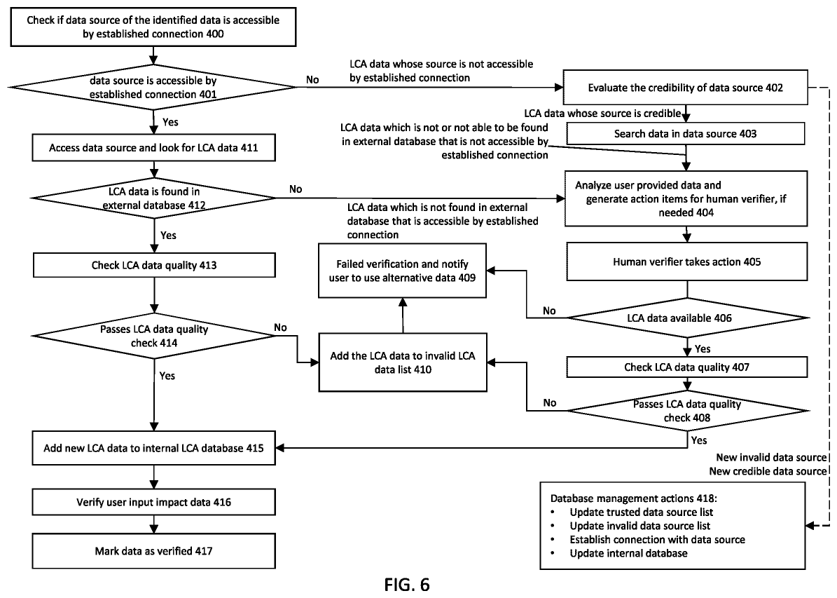

FIG. 6 is a flow diagram illustrating an LCA data verification process in detail according to various embodiments. This process may relate to the steps 207 to 212 as described with reference to FIG. 4.

In some embodiments, in step 400, the data engine 1016 may check if the LCA data source 1014 of the target LCA data is accessible by an established connection. In some embodiments, if the target data source 1014 of the target LCA data is accessible by the established connection, the data engine 1016 may assess the target data source 1014 using the established connection, and search for the target LCA data in the target data source 1014 in step 411. In some embodiments, in step 413, if the target LCA data is found in the target data source 1014, the LCA data quality evaluation module 1007 may evaluate the quality of the target LCA data using a process which will be described below. In some embodiments, in step 415, if the target LCA data passes the LCA data quality check, the target LCA data may be added to the internal LCA database 1008 by a data engine (not shown). In some embodiments, in step 416, the data engine 1016 may verify the impact data (also referred to as “user input impact data”) by comparing the impact data with the respective target LCA data in the target data source 1014. In some embodiments, in step 417, if the impact data matches with the target LCA data, the target LCA data may be marked as verified. In some embodiments, if the impact data does not match with the target LCA data, the target LCA data may be corrected, and the user may be informed of the correction.

In some embodiments, in step 402, the SourceVerify AI 1003 may evaluate the credibility of the target data source 1014 which is not accessible by the established connection. In some embodiments, in step 418, if the result generation module 1003g deems the target data source 1014 credible, the data engine 1016 may add a name of the target data source 1014 to the trusted data source list 1002a. In some embodiments, the data engine 1016 may establish a connection with the target data source 1014, where possible. In some embodiments, a data engine (not shown) may update the internal LCA database 1008 based on the target data source 1014. In some embodiments, if the result generation module 1003g deems the target data source 1014 incredible, the name of the target data source 1014 may be added to the invalid data source 1002b.

In some embodiments, in step 403, if the result generation module 1003g deems the target data source 1014 credible, the data engine 1016 may search the target LCA data in the target data source 1014. In some embodiments, if the target LCA data is not or not able to be found in the target data source 1014 in the step 403 or the target LCA data is not found in an external database that is accessible by the established connection in step 411, the authenticity evaluation module 1005 may analyse the likelihood of the user provided data being truthful and the action item generation module 1004 may generate necessary action items and useful information for the human verifier in step 404. In some embodiments, in step 405, the human verifier may take actions based on the necessary action items and useful information generated in the step 404. An example of the action item is contacting a data source administrator and obtaining the LCA data.

In some embodiments, in step 409, if the target LCA data is still unavailable, the target LCA data may be marked as “failed verification” and the user may be notified to use alternative LCA data.

In some embodiments, in step 407, if the target LCA data is available, the quality of the target LCA data may be checked. In some embodiments, if the target LCA data passes the LCA data quality check, the process may proceed to the steps 415, 416 and 417.

In some embodiments, if the target LCA data fails the LCA data quality check in steps 414 or 408, the data engine 1016 may add the target LCA data to the invalid data list 1002c in step 410, the target LCA data may be marked as “failed verification”, and the user may be notified to use alternative LCA data in the step 409.

In some embodiments, the credibility of the target data source 1014 on both the trusted data source 1002a and the invalid data source 1002b may be re-evaluated by the Source Verify AI 1003, periodically or in response to triggers. In some embodiments, a purpose of the re-evaluation may be to maintain the high credibility of all the target data sources on the trusted data source list, because there may be changes in the target data sources, for example, becoming less objective or decreased LCA data quality. In some embodiments, the results of LCA data quality check (step 413) may be used for the re-evaluation of the credibility of the target data source 1014.

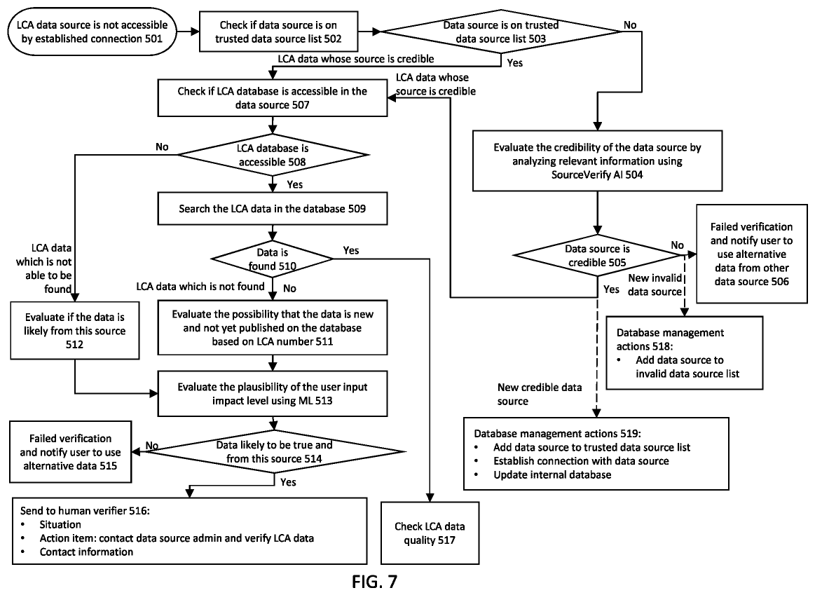

FIG. 7 is a flow diagram illustrating a process when a data source is not accessible by an established connection according to various embodiments. FIG. 7 shows the process to evaluate the target data source 1014, search the target LCA data, analyse the target LCA data, generate the action items, and update the internal LCA database 1008 when the target data source 1014 is not accessible by the established connection.

This process may relate to the steps 402, 403, 404 and 418 as described with reference to FIG. 6. In FIG. 7, steps 501, 502, 503, 504, 505 and 506 may relate to the step 402 of FIG. 6, steps 507, 508, 509 and 510 may relate to the step 403 of FIG. 6, steps 511, 512, 513, 514, 515, 516 may relate to the step 404 of FIG. 6, and steps 518 and 519 may relate to the step 418 of FIG. 6.

In some embodiments, in the step 502, the target data source identification module 1013b may determine if the target data source 1014, which is not accessible by the established connection, needs to be further evaluated by checking the target data source 1014 against the trusted data source list 1002a. In some embodiments, in the step 504, the SourceVerify AI 1003 may evaluate the credibility of the target data source 1014 by analysing relevant information.

In some embodiments, in the step 506, if the target data source 1014 is found incredible, the target LCA data may be marked as “failed verification” and the user may be notified to use alternative LCA data from other data source. In some embodiments, in the step 518, if the target data source 1014 is found incredible, the data engine 1016 may add the target data source 1014 to the invalid data source list 1002b.

In some embodiments, in the step 519, if the target data source 1014 is found credible, the data engine 1016 may add the name of the target data source 1014 to the trusted data source list 1002a. In some embodiments, the data engine 1016 may establish a connection with the target data source 1014, where possible. In some embodiments, a data engine (not shown) may update the internal LCA database 1008 based on the target data source 1014. In some embodiments, if the result generation module 1003g deems the target data source 1014 incredible, the name of the target data source 1014 may be added to the invalid data source 1002b.

In some embodiments, in the step 507, the data engine 1016 may attempt to access the LCA database of the target data source 1014, which has been found to be trusted but whose LCA database is not accessible by the established connection, using data extraction techniques such as web scraping and search the target LCA data.

In some embodiments, in the step 509, if the internal LCA database 1008 is accessible, the data engine 1016 may search the target LCA data in the internal LCA database 1008. In some embodiments, in the step 517, if the target LCA data is found in the internal LCA database 1008, the LCA data quality evaluation module 1007 may check the quality of the target LCA data.

In some embodiments, in the step 511, if the target LCA data is not found in the internal LCA database 1008, the authenticity evaluation module 1005 may evaluate the possibility that the target LCA data is new and not yet published on the internal LCA database 1008 based on the LCA number.

In some embodiments, in the step 512, for the target LCA data that is in the internal LCA database 1008 that is not accessible, the authenticity evaluation module 1005 may evaluate the likelihoods of the target LCA data coming from the target data source 1014 by methods, such as checking the format of the LCA number against the registration number format of the internal LCA database 1008 (if known).

In some embodiments, in the step 513, the impact level evaluation module 1006 may predict the impact levels of the target LCA product and evaluate the plausibility of the user input impact by comparing the user provided and normalised impact levels with the predicted impact levels. In some embodiments, the authenticity evaluation module 1005 may obtain the evaluation results from the impact level evaluation module 1006.

In some embodiments, in the step 516, if the target LCA data is found likely to be true and from the provided target data source 1014, the action item generation module 1004 may generate action items and useful information for the human verifiers to further verify the target LCA data. Otherwise, in some embodiments, in the step 515, the target LCA data may be marked as “failed verification” and the user may be notified to use alternative LCA data.

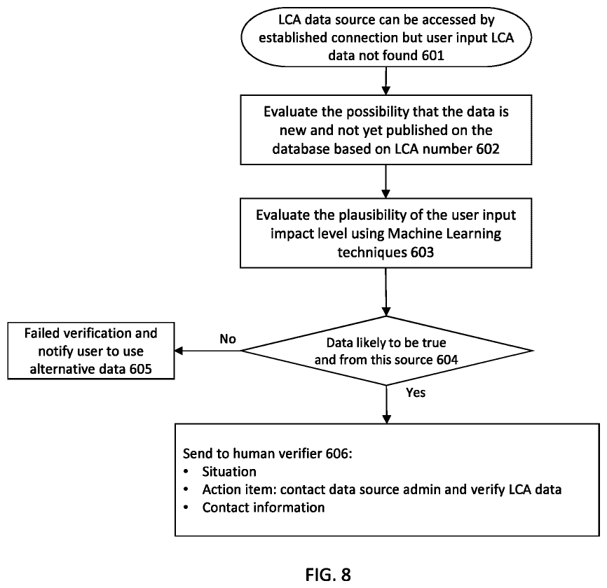

FIG. 8 is a flow diagram illustrating a process, when a data source is accessible by an established connection, but LCA data is not found, according to various embodiments. This process may relate to the step 404 as described with reference to FIG. 6. FIG. 8 shows the process to analyse the target LCA data and generate action items, when the target data source 1014 is accessible by the established connection, but the target LCA data is not found.

In some embodiments, in step 602, for the scenario that the target data source 1014 is accessible by the established connection but user input target LCA data is not found in the target data source 1014, the authenticity evaluation module 1005 may evaluate the possibility that the target LCA data is new and not yet published on the internal LCA database 1008 based on the LCA number.

In some embodiments, in step 603, the impact level evaluation module 1006 may predict the impact levels of the target LCA product and evaluate the plausibility of the user input impact by comparing the user provided and normalised impact levels with the predicted impact levels. In some embodiments, the authenticity evaluation module 1005 may obtain the evaluation results from the impact level evaluation module 1006.

In some embodiments, in step 606, if the target LCA data is found likely to be true and from the provided target data source 1014, the action item generation module 1004 may generate the action items and useful information for the human verifiers to further verify the target LCA data. Otherwise, in some embodiments, in step 605, the target LCA data may be marked as “failed verification” and the user may be notified to use alternative LCA data.

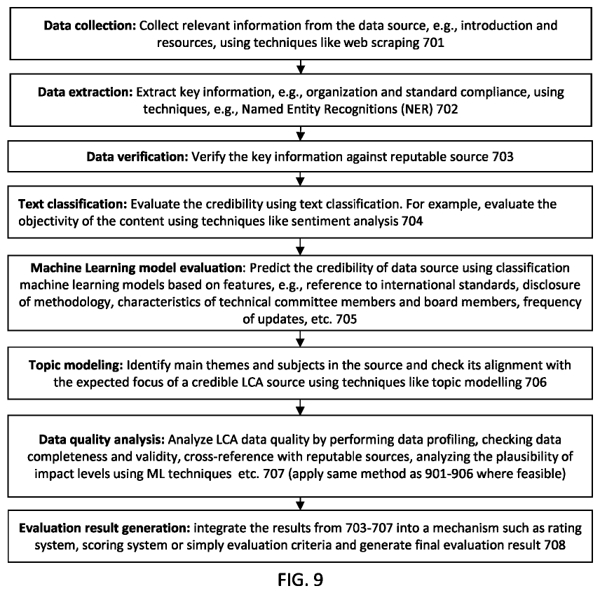

FIG. 9 is a flow diagram illustrating a process to evaluate credibility of a data source using a SourceVerify AI 1003 according to various embodiments. This process may relate to the step 504 as described with reference to FIG. 7. In some embodiments, the Source Verify AI 1003 may evaluate the credibility of the target data source 1014 with the following processes:

In some embodiments, in step 701, the data collection module 1003a may collect relevant data from the target data source 1014, for example, introduction and resources, using techniques for example, the web scraping.

In some embodiments, in step 702, the data extraction module 1003b may extract key information, for example, organisations and standard compliance, using techniques, for example, Named Entity Recognitions (NER) from the collected data.

In some embodiments, in step 703, the data verification module 1003c may verify the key information against the other trusted data sources 1010.

In some embodiments, in step 704, the text classification module 1003h may evaluate the credibility of the target data source 1014 using text classification techniques based on the collected data from the step 701. For example, the text classification module 1003h may evaluate an objectivity of a content using techniques such as a sentiment analysis.

In some embodiments, in step 705, the credibility prediction module 1003d may predict the credibility of the target data source 1014 using the predefined classification machine learning model from the machine learning models 1002f, based on the features, for example, the reference to international standards, the disclosure of methodology, the characteristics of technical committee members, the frequency of updates, etc., which are extracted in the step 702.

In some embodiments, in step 706, the theme evaluation module 1003e may identify main themes and subjects of the target data source 1014 and check its alignment with an expected focus of a credible LCA data source using techniques such as topic modelling.

In some embodiments, in step 707, the LCA data analysis module 1003f may analyse the quality of the target LCA data by performing data profiling, checking data completeness and validity of the target LCA data, a cross-reference with reputable sources, analysing the plausibility of impact levels using ML techniques, etc. In some embodiments, the LCA data analysis module 1003f may call the LCA data quality evaluation module 1007 to perform at least one of the above-mentioned functions.

In some embodiments, in step 708, the result generation module 1003g may integrate the results from the steps 703 to 707 into a mechanism such as a rating system, a scoring system, or evaluation criteria, and generate the evaluation result.

In some embodiments, all or part of the steps 703 to 707 may be applied and other AI techniques may be applied in addition to them. In some embodiments, the order of the steps 703 to 707 may be changed.

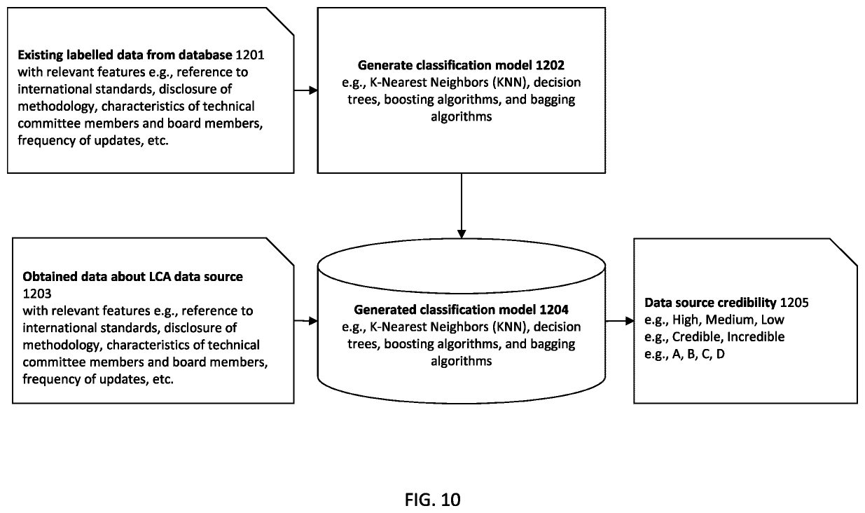

FIG. 10 is a flow diagram illustrating a process to predict data source credibility using a classification machine learning model according to various embodiments. This process may relate to the step 705 as described with reference to FIG. 9.

In some embodiments, the classification machine learning model (also referred to as a “classification model”), which is one of the machine learning models 1002f, may be used by the credibility prediction module 1003d to predict the credibility of the target data source 1014. In some embodiments, in step 1202, the classification machine learning model may be generated in a machine learning model generation process including a data preparation, an exploratory analysis, a feature extraction, a model training, and a model validation. Examples of the modelling algorithms may be K-Nearest Neighbours (KNN), decision trees, boosting algorithms, and bagging algorithms.

In some embodiments, data used to generate the classification machine learning model may be existing labelled data from a database 1201 with relevant features, for example, the reference to international standards, the disclosure of methodology, the characteristics of technical committee members, the frequency of updates, etc.

In some embodiments, an output of the classification machine learning model may be ratings relating to the credibility of the target data source 1014. An example of the output may be “High Credibility”, “Medium Credibility”, and “Low Credibility”. Another example of the output may be “Credible”, and “Incredible”. In some embodiments, the rating may also be indicators, for example, “A”, “B”, “C” and “D”.

In some embodiments, after the classification machine learning model 1204 is generated and validated in step 1202, the classification machine learning model 1204 may be deployed and used to predict the credibility of the target data source 1014. In some embodiments, in step 1203, the credibility prediction module 1003d may obtain the required input data from the data extraction module 1003b and input the obtained data into the classification machine learning model 1204 to generate the output 1205.

In some embodiments, the classification machine learning model 1204 may be updated periodically or in response to triggers in a machine learning pipeline using new data.

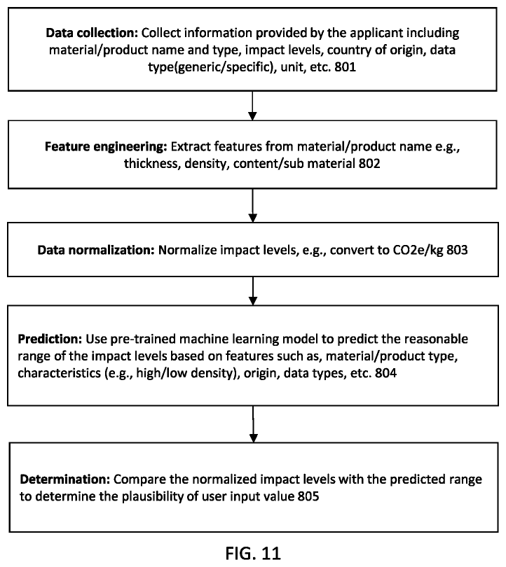

FIG. 11 is a flow diagram illustrating a process to predict reasonable impact levels according to various embodiments. This process may relate to the step 513 as described with reference to FIG. 7 and the step 603 as described with reference to FIG. 8. In some embodiments, the impact level evaluation module 1006 may predict the reasonable range of the impact level with the following process.

In some embodiments, in step 801, the data collection module 1006a may collect information from the LCA data provided by the applicant, including material/product name and type, impact levels, country of origin, data type (generic/specific), unit, etc. For example, the material may be a raw material such as cement and a glass, and the project may be an item of a certain brand such as an air conditional, a window and a door. In some embodiments, the material and/or the project may be analysed.

In some embodiments, in step 802, the feature extraction module 1006b may extract features from the material/product name, for example, thickness, density, content/sub material, using techniques, for example, Named Entity Recognitions (NER).

In some embodiments, in step 803, the data normalisation module 1006c may normalise the impact levels, for example, converting to CO₂ e/kg.

In some embodiments, in step 804, the impact level prediction module 1006d may use the pre-trained regression machine learning model from the machine learning models 1002f, to predict reasonable impact levels based on features such as, the material/product type, the material/product characteristics (for example, the high/low density), the origin, the data types, etc.

In some embodiments, the machine learning model may be created using machine learning algorithms based on existing LCA data.

In some embodiments, the machine learning model may be updated periodically or in response to triggers in a machine learning pipeline using new LCA data.

In some embodiments, in step 805, the result generation module 1006e may compare the normalised impact levels with the predicted range, to determine the plausibility of user input value.

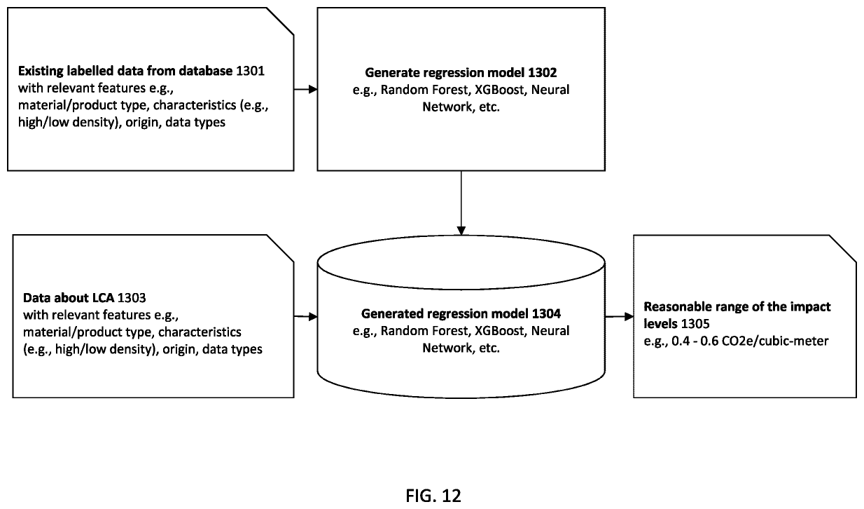

FIG. 12 is a flow diagram illustrating a process to predict a reasonable range of impact levels using a regression machine learning model according to various embodiments. This process may relate to the step 705 as described with reference to FIG. 9.

In some embodiments, the regression machine learning model (also referred to as a “regression model”), which is one of the machine learning models 1002f, may be used by the impact level prediction module 1006d to predict reasonable impact levels based on features such as, the material/product type, the material/product characteristics (for example, the high/low density), the origin, the data types, etc.

In some embodiments, in step 1302, the regression machine learning model may be generated in a machine learning model generation process including a data preparation, an exploratory analysis, a feature extraction, a model training, and a model validation. Examples of the modelling algorithms may be Random Forest, XGBoost, Neural Network, etc.

In some embodiments, data used to generate the regression machine learning model may be existing labelled data from a database 1301 with relevant features, for example, the material/product type, the characteristics (for example, the high/low density), the origin, the data types, etc.

In some embodiments, an output of the regression machine learning model may be a reasonable range of the impact levels 1305, for example, 0.4-0.6 CO₂ e/cubic meter. In some embodiments, the reasonable range may be generated based on prediction intervals, which provide a range within which the actual target value is likely to fall with a certain level of confidence.

In some embodiments, after the regression machine learning model 1304 is generated and validated in step 1302, the regression machine learning model 1304 may be deployed and used to predict reasonable impact levels. In some embodiments, in step 1303, the impact level prediction module 1006d may obtain the required input data from the feature extraction module 1006b and input the obtained data into the regression machine learning model 1304 to generate the output 1305.

In some embodiments, the regression machine learning model 1304 may be updated periodically or in response to triggers in a machine learning pipeline using new data.

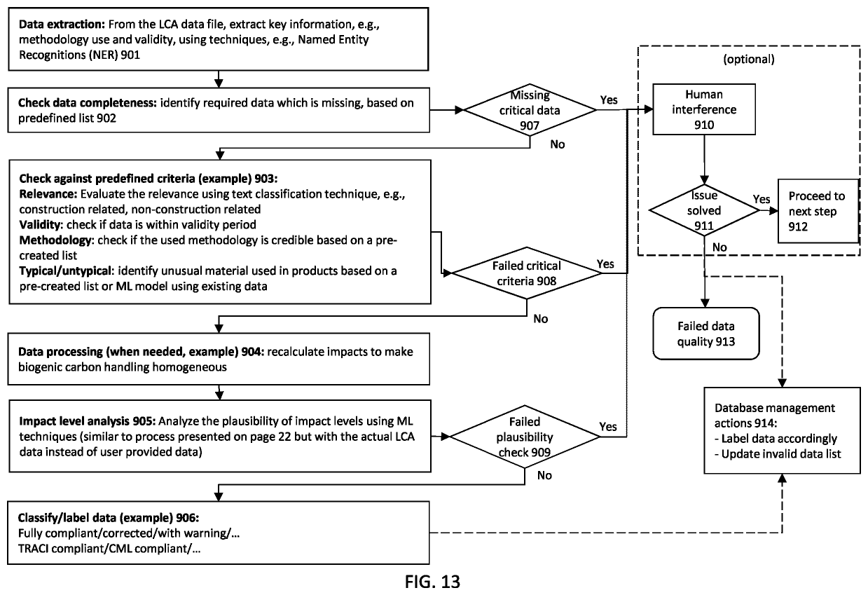

FIG. 13 is a flow diagram illustrating a process to evaluate an LCA data quality according to various embodiments. This process may relate to the steps 407 and 413 as described with reference to FIG. 6, and the step 517 as described with reference to FIG. 7. In some embodiments, once LCA data is found in a trusted data source, the quality of the LCA data may be checked in the following process, as shown in FIG. 13.

In some embodiments, in step 901, the data extraction module 1007a may extract key information, for example, a methodology use and validity, using techniques, for example, Named Entity Recognitions (NER), from the LCA data file.

In some embodiments, in step 902, the data completeness evaluation module 1007b may identify required data, which is missing, based on a predefined list in the data storage 1002 (not shown).

In some embodiments, in step 903, the criteria evaluation module 1007c may check the LCA data against the predefined criteria 1002e, such as a relevance, a validity, a methodology, typical/untypical, etc.

In some embodiments, in step 904, the data processing module 1007d may process the LCA data such as recalculating impacts to make biogenic carbon handling homogeneous.

In some embodiments, in step 905, the impact level assessment module 1007e may assess the plausibility of impact levels using the impact level evaluation module 1006.

In some embodiments, in step 906, the labelling module 1007f may classify or label the LCA data, such as fully compliant/corrected/with warning.

In some embodiments, in step 910, the human interference may be requested by the LCA data quality evaluation module 1007 using the action item generation module 1004, in situations of missing critical data, failed critical criteria, failed plausibility check to solve the problem.

In some embodiments, in step 914, the data engine 1016 may obtain LCA data quality evaluation results from the LCA data quality evaluation module 1007 and send the results to the internal LCA database 1008, and update the invalid data 1002c.

FIG. 14 is a block diagram illustrating a system architecture of an LCA tool using a blockchain according to various embodiments. In some embodiments, the proposed solution may be implemented in a system architecture using a blockchain as shown in FIG. 14.

In some embodiments, the proposed LCA database system may be implemented in a blockchain database 1101. In some embodiments, the functions of the AI verifier 1001 may be implemented using a smart contract 1101b. Therefore, in some embodiments, the smart contracts 1101b may automatically detect, verify, and add new LCA database 1101a from LCA project database 1101c. In some embodiments, the smart contract 1101b may automatically detect, verify, and add the new LCA database 1101a from an external LCA database 1102 (also referred to as an “external data source”).

In some embodiments, the verified LCA project database 1101c may also be stored in the blockchain.

In some embodiments, the smart contract 1101b may calculate an eligibility of certification and/or an amount of carbon credits of the project 1101d.

In some embodiments, the smart contract 1101b may send information about the eligibility of certification and/or the amount of carbon credits to external certification system and/or carbon trading system 1103.

In some embodiments, new building assembly data from the new project database 1101c may also be added to the internal LCA database 1101a. In some embodiments, the assembly data may be helpful in an early design stage LCA analysis.

In some embodiments, an LCA calculator 1104 may obtain LCA data from the internal LCA database 1101a to conduct the life-cycle assessment for a project by an LCA assessment module 1104a.

In some embodiments, the LCA calculator 1104 may include functions for predicting an operational energy use of the project using an energy simulation 1104b.

In some embodiments, the LCA calculator 1104 may include functions 1104c to optimise the project by providing recommendations on a design and a selection of materials/parts/components.

In some embodiments, the LCA calculator 1104 may import and/or export information from other related software 1106 used in the industry, such as BIM (Building Information Modelling) software.

In some embodiments, the LCA calculator 1104 may collect user input information 1105 which is needed in the life-cycle assessment.

In some embodiments, the LCA calculator 1104 may perform the life-cycle assessment, and send the information of design and assessment results to the blockchain database 1101 for a verification.

As described above, the various embodiments may use the blockchain with the smart contract technology to automatically add the verified LCA data, and thus may ensure transparency.

FIG. 15 is a flow diagram illustrating a method for facilitating a verification of LCA data according to various embodiments.

In some embodiments, the method may include a step 1210 of detecting LCA data from an LCA data source.

In some embodiments, the method may include a step 1220 of identifying information relating to a quality of the LCA data (the target LCA data) and a quality of the LCA data source (the target data source 1014) using a natural language processing (NLP) technique.

In some embodiments, the method may include a step 1230 of evaluating credibility of the LCA data source (the target data source 1014) using a first machine learning model, for example, a classification machine learning model, based on the identified information relating to the quality of the LCA data source (the target data source 1014).

In some embodiments, the method may include a step 1240 of evaluating a plausibility of an impact level using a second machine learning model, for example, a regression machine learning model, based on the identified information relating to the quality of the LCA data (the target LCA data).

In some embodiments, the method may include a step 1250 of verifying the LCA data (the target LCA data) as either valid data or invalid data, based on the evaluated credibility of the LCA data source (the target data source 1014) and the evaluated plausibility of the impact level.

Although not shown, in some embodiments, the method may further include a step of updating an LCA database using the verified LCA data (the target LCA data).

As described above, the various embodiments may add multiple layers of AI-based verifications/filters to reduce the amount of information passed to the human verifiers and support the human verifier's tasks. In addition, the various embodiments may identify new sources more efficiently by obtaining information from the applicants of LCA projects.

As described above, the various embodiments may address limitations of the prior art. For example, in the step 402 of evaluating the credibility of the target data source 1014 (as described with reference to FIG. 6), as explained in the steps 701 to 707 (as described with reference to FIG. 9), the various embodiments may use a combination of multiple rule-based and AI techniques to enhance the reliability of the data source evaluations, instead of determining data ingestion or rejection solely on a simply rule-based initial evaluation.

In addition, the various embodiments may accurately predict the credibility of the target data source 1014, by employing models capable of categorising target data sources based on specific features. (as described with reference to the step 705 of FIG. 9).

Furthermore, the various embodiments may introduce a unique aspect with data quality analysis specifically tailored for the LCA data (as described with reference to the step 707 of FIG. 9). This distinct feature may further enhance the ability to ensure the credibility of the target data source 1014.

In this regard, the various embodiments may achieve higher accuracy of evaluating data source credibility, higher efficiency of evaluating LCA data quality, and high data integrity because of reduced human error.

In addition, the various embodiments may reduce costs of maintaining the database of the LCA tool, and thus it may be desired by entities who are owner, developer and/or an operator of the LCA tool. The various embodiments may solve the problems for building the life-cycle assessment, but it may be appreciated that the various embodiments may be applied to the life-cycle assessment of other products, such as infrastructures (for example, manufacturing an equipment and/or industrial facilities) and complex products (for example, automobiles, electronic devices, etc.).

The various embodiments may also be used to detect greenwashing claims by using the AI verifier 1001 to evaluate the credibility of the LCA data source and the plausibility and the quality of the LCA data used in the claims. The various embodiments may also be used to detect greenwashing in individual LCA documents, for example, EPD files, by using the AI verifier 1001 to evaluate the credibility of the document's data source and the plausibility and the quality of data inside the document.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A server for facilitating a verification of life-cycle assessment (LCA) data, the server comprising:
a memory configured to store instructions; and
a processor configured to execute the stored instructions and configured to:
detect LCA data from an LCA data source;
identify information relating to a quality of the LCA data and a quality of the LCA data source using a natural language processing (NLP) technique;
evaluate credibility of the LCA data source using a first machine learning model based on the identified information relating to the quality of the LCA data source;
evaluate a plausibility of an impact level using a second machine learning model based on the identified information relating to the quality of the LCA data; and
verify the LCA data as either valid data or invalid data, based on the evaluated credibility of the LCA data source and the evaluated plausibility of the impact level.

2. The server according to claim 1, wherein the processor is further configured to:
obtain project data for a project from a project database; and
store the project data in a data storage as temporary data,
wherein the data storage stores at least one of a trusted data source, an invalid data source, invalid data, and a valid data format.

3. The server according to claim 2, wherein the processor is further configured to identify the LCA data that needs to be verified among the project data stored as the temporary data, based on at least one of the invalid data source, the invalid data, and the valid data format stored in the data storage and an internal LCA database.

4. The server according to claim 3, wherein the processor is further configured to identify the LCA data source whose credibility needs to be evaluated among the identified LCA data, based on the trusted data source saved in the data storage.

5. The server according to claim 1, wherein the first machine learning model is a classification machine learning model, and the second machine learning model is a regression machine learning model.

6. The server according to claim 1, wherein the processor is configured to evaluate the credibility of the LCA data source by:
collecting data including the information relating to the quality of the LCA data and the quality of the LCA data source from the LCA data source using a data collection module;
extracting the information relating to the quality of the LCA data and the quality of the LCA data source from the collected data using a data extraction module;
verifying the extracted information based on information obtained from a trusted LCA data source using a data verification module;
evaluating the credibility of the LCA data source using a text classification module;
predicting the credibility of the LCA data source using a credibility prediction module;
evaluating themes of the LCA data source using a theme evaluation module;
evaluating the quality of the LCA data using an LCA data analysis module; and
generating a final evaluation result using a result generation module.

7. The server according to claim 1, wherein the processor is further configured to search the LCA data in the LCA data source which is evaluated credible.

8. The server according to claim 7, wherein the processor is further configured to:
for another LCA data that is not found in the LCA data source, analyse likelihood that the another LCA data is true based on the impact level; and
generate an action item for a verifier based on the likelihood that the another LCA data is true.

9. The server according to claim 7, wherein the processor is further configured to, for the LCA data that is found in the LCA data source, extract data relating to the quality of the LCA data, evaluate data completeness of the LCA data, evaluate the quality of the LCA data against pre-defined LCA data quality criteria, process the LCA data, and evaluate the plausibility of the impact level.

10. The server according to claim 2, wherein the processor is further configured to:
check if all the LCA data has been verified;
for the project that all the LCA data has been verified, send a verification result to the project database; and
for the project that at least a part of the LCA data has not been verified, send the verification result to the project database, and return the project to an applicant for an action.

11. A method for facilitating a verification of life-cycle assessment (LCA) data, the method comprising:
detecting LCA data from an LCA data source;
identifying information relating to a quality of the LCA data and a quality of the LCA data source using a natural language processing (NLP) technique;
evaluating credibility of the LCA data source using a first machine learning model based on the identified information relating to the quality of the LCA data source;
evaluating a plausibility of an impact level using a second machine learning model based on the identified information relating to the quality of the LCA data; and
verifying the LCA data as either valid data or invalid data, based on the evaluated credibility of the LCA data source and the evaluated plausibility of the impact level.

12. The method according to claim 11 further comprising:
obtaining project data for a project from a project database; and
storing the project data in a data storage as temporary data,
wherein the data storage stores at least one of a trusted data source, an invalid data source, invalid data, and a valid data format.

13. The method according to claim 12 further comprising: identifying the LCA data that needs to be verified among the project data stored as the temporary data, based on at least one of the invalid data source, the invalid data, and the valid data format stored in the data storage and an internal LCA database.

14. The method according to claim 13 further comprising: identifying the LCA data source whose credibility needs to be evaluated among the identified LCA data, based on the trusted data source saved in the data storage.

15. The method according to claim 11, wherein the first machine learning model is a classification machine learning model, and the second machine learning model is a regression machine learning model.

16. The method according to claim 11, wherein the evaluating the credibility of the LCA data source further comprises:
collecting data including the information relating to the quality of the LCA data and the quality of the LCA data source from the LCA data source using a data collection module;
extracting the information relating to the quality of the LCA data and the quality of the LCA data source from the collected data using a data extraction module;
verifying the extracted information based on information obtained from a trusted LCA data source using a data verification module;
evaluating the credibility of the LCA data source using a text classification module;
predicting the credibility of the LCA data source using a credibility prediction module;
evaluating themes of the LCA data source using a theme evaluation module;
evaluating the quality of the LCA data using an LCA data analysis module; and
generating a final evaluation result using a result generation module.

17. The method according to claim 11 further comprising: searching the LCA data in the LCA data source which is evaluated credible.

18. The method according to claim 17 further comprising:
for another LCA data that is not found in the LCA data source, analysing likelihood that the another LCA data is true based on the impact level; and
generating an action item for a verifier based on the likelihood that the another LCA data is true.

19. The method according to claim 17 further comprising: for the LCA data that is found in the LCA data source, extracting data relating to the quality of the LCA data, evaluate data completeness of the LCA data, evaluating the quality of the LCA data against pre-defined LCA data quality criteria, processing the LCA data, and evaluating the plausibility of the impact level.

20. The method according to claim 12 further comprising:
checking if all the LCA data has been verified;
for the project that all the LCA data has been verified, sending a verification result to the project database; and
for the project that at least a part of the LCA data has not been verified, sending the verification result to the project database, and returning the project to an applicant for an action.
